(19) United States
(12) Patent Application Publication
(10) Pub. No.: US 2011/0320970 A1
(43) Pub. Date: Dec. 29, 2011

(54) Method And System For Controlling A User Interface Of A Software Application

(75) Inventors: Chiheb Charrad, Neunkirchen A. Brand (DE); Christian Scharf, Aurachtal (DE)

(73) Assignee: SIEMENS AKTIENGESELLSCHAFT, Munich (DE)

(21) Appl. No.: 13/169,146

(22) Filed: Jun. 27, 2011

(30) Foreign Application Priority Data
Jun. 29, 2010 (DE) 10 2010 025 480.0

(51) Int. Cl. G06F 3/048

(52) U.S. Cl. 715/765

(57) ABSTRACT

A method and system for controlling a user interface of a software application which is executed in a runtime environment are disclosed which are easy to implement and manage, yet at the same are also flexible. It is provided according to at least one embodiment of the invention to store in relation to at least one element of the user interface within the scope of the application or a configuration file assigned thereto a specification defining the type and attributes of the at least one element. After the start of the application, the at least one element is then created in accordance with the associated specification by an element control module that is separate from the application.

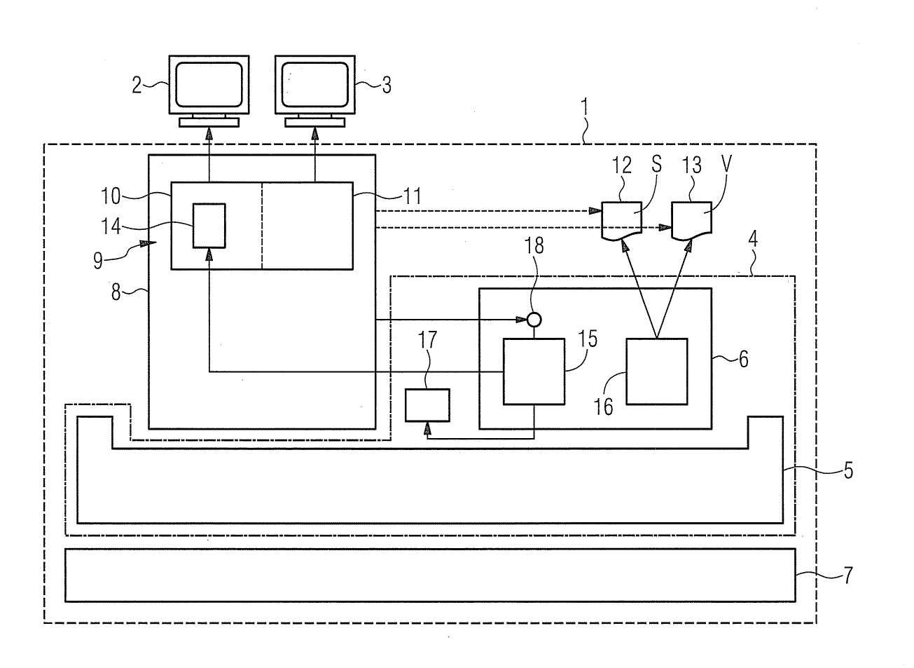

### PRIORITY STATEMENT

The present application hereby claims priority under 35 U.S.C. §119 on German patent application number DE 10 2010 025 480.0 filed Jun. 29, 2010, the entire contents of which are hereby incorporated herein by reference.

### FIELD

At least one embodiment of the invention generally relates to a method for controlling a user interface of a (software) application that is executed in a runtime environment. At least one embodiment of the invention furthermore relates to a (hardware and/or software) system for performing the method.

### BACKGROUND

Modern software applications (i.e. application programs), in particular software applications for medical imaging, frequently have a complex user interface (UI) composed of a multiplicity of individual (UI) elements. In per se conventional technology said elements include for example alphanumeric input fields, display fields for text or images, or graphical simulations of buttons, check boxes, sliders, knobs, etc. A UI element can in its turn consist of a combination of a plurality of subordinate UI elements. In contrast hereto, the term “atomic” designates a type of UI elements that cannot be subdivided any further into subunits without loss of functionality, e.g. an individual slider.

On account of the multiplicity of elements contained in the user interface it is usually not possible to display all of them on a single screen simultaneously in a clear and uncluttered form. For this reason the user interface of a medical software application typically has a plurality of layers, only one of which is ever displayed in full and between which it is possible to “thumb through” in the manner of index cards or tabs. In addition or alternatively the user interface of a medical software application often extends over a plurality of screens.

In such a complex user interface flexibility and performance are paramount. Desirable in particular is a means of controlling the user interface which allows individual UI elements to be created, not straight away at the start of the software application, but only later at the runtime of the application. This is advantageous in particular for UI elements
a. which are subject to licensing, i.e. which are linked for example to functions of the application that are available only at a specific license level,
b. which for performance reasons are not to be created at the start of the application because for example they are only rarely used,
c. which prove to be necessary only at the runtime of the application as a result of the interaction with the user (e.g. fields for search and sort criteria), or
d. which are subject to version management aspects, i.e. which are to be available e.g. only in certain versions of the application, individual parts of the application or other programs or files related thereto, or which are to have a different appearance and/or different functionality in different versions of the application, individual parts of the application or other programs or files related thereto.

In this context “control” of the user interface is understood to refer to computerized instructions by which UI elements are created, destroyed or influenced in terms of their attributes, in particular their graphical look-and-feel, their function and/or their arrangement on the user interface.

In order to be able to design flexible, in particular application-specific, user interfaces, the UI elements are conventionally often generated programmatically, i.e. by way of the program code of the software application itself. However, this programmatic approach is problematic with regard to versioning aspects. In this regard, namely, the application must usually be connected via a static link to a controls library. If the controls library is changed at a subsequent time, it may disadvantageously be necessary to rewrite all the applications that use the library.

According to another method, the UI elements that are not required or not immediately required are also created at the start of the application, but are hidden. Although present at the start of the application, therefore, the UI elements are not yet visible, and will be visibly superimposed on the user interface by the application only at a later time. However, this approach does not help greatly in reducing the computing power required at the start of the application and is therefore critical from the performance optimization perspective.

In DE 10 2007 052 813 B3, it is in turn proposed as an alternative, after the original application has been started, to start a sub-application that is logically linked thereto, and to assign separate display areas, in particular different screens, to the application and sub-application in each case. With this solution, therefore, different groups of UI elements are in each case created by a separate sub-application, as a result of which said groups can also be created at the runtime of the original application. This approach can therefore be combined with the scenarios enumerated above. That said, however, its implementation requires a comparatively great amount of time and effort, in particular on the part of the application developer.

### SUMMARY

In at least one embodiment of the invention, a method is disclosed that is comparatively easy to implement and allows flexible control of a user interface of a software application, in particular the creation of flexibly configurable elements of the user interface after the start (i.e. at the runtime) of the application. In at least one embodiment of the invention, a (hardware and/or software) system is implemented that is particularly suitable for automatically performing the method.

With regard to at least one embodiment, a method is achieved; and with regard to at least one other embodiment, a system is achieved. Advantageous embodiments and developments of the invention are set forth in the dependent claims and in the following description.

The system according to at least one embodiment, the invention comprises a runtime environment in which the software application can be executed and also an element creation module (referred to in the remainder of this description as a “part factory” for short) for creating as well as optionally also for destroying at least one element of the user interface (UI element).

The runtime environment is constituted by what is termed middleware, that is to say software which is interposed between the operating system and the actual application. In real terms the runtime environment is software that is executed in conjunction with a software application which cannot communicate directly with the operating system and makes the application executable, in other words able to run, on the respective computer by mediating between the application and the operating system.

The part factory is software which is separate from the application and preferably executes in the same runtime environment as the software application. In this case the part factory is preferably implemented in an application-independent manner as part of a “framework” which also includes the runtime environment. The “framework” is a software structure or software platform which in itself does not constitute an application, but which provides ready-made functions or components to an application running on top of it. The framework within which the part factory is implemented is preferably what is called a domain-specific framework which makes available specialized functionalities for the field of medical imaging.

It is provided according to at least one embodiment of the invention, at least for one (in particular atomic) element of the user interface, to store a specification that defines the type and attributes of the element. The specification can be stored as part of the application itself. Preferably, however, it is stored in a configuration file assigned to the application. Within the scope of the specification, one of the element types “text input field”, “text display field”, “graphical display field”, “button”, “switch”, “slider” and “knob”, for example, can be specified as information relating to the “type” of the UI element. Within the scope of the specification, the size, graphical appearance, color and behavior of the respective element type, for example, can be defined as “attributes”. In this context the “behavior” can be determined for example by parameters specifying the switching behavior, output or marginal values and/or half toning. Thus, with regard to the “switching behavior” of an element of the type “button”, it can be defined for example whether the button is to function as a “toggle” (i.e. bistable pushbutton) or as a monostable pulse generator. In principle, however, the parameters specifiable as part of the specification in relation to type and attributes of the UI elements that are to be configured can be freely chosen within the scope of the invention. The specification can contain in particular an arbitrary sub-combination of the above-cited parameters and/or include further parameters. Furthermore, conventional possibilities for flexible configuration of UI elements, as are known per se e.g. from DE 10 2005 041 629 A1 (the entire contents of which are hereby incorporated herein by reference), can be used to their full extent also in the specifications according to at least one embodiment of the invention.

According to at least one embodiment of the invention, the element is created by the part factory in accordance with the associated specification after the start of the application, in other words at the runtime of the application.

In an example embodiment, the specification specifies “element types”, i.e. models or templates for UI elements, each of which can be instantiated more than once by the part factory. In this case, therefore, the part factory can create e.g. each button, slider, etc. specified by type in multiple instances (i.e. incarnations) on the user interface. In an alternative embodiment of the invention it can, however, also be provided that each UI element described in the specification can be created only once on the user interface by the part factory.

By way of the part factory separated from the actual application it is advantageously made possible for UI elements to be created and if necessary destroyed totally independently of the start of the application at arbitrarily predefinable times during the runtime of the application, without the requirement for the application developer personally to write the actual generation logic. In this case, however, by virtue of the specification which is in turn independent of the part factory, the application developer can nevertheless design the type and attributes of the UI elements with a substantial degree of freedom. The combination of the part factory, which is separated from the application and contains the generation logic, with an application-specific configuration section containing the specification of said elements therefore enables a highly flexible means of control of the user interface which is at the same time easy to implement and manage—in particular for the application developer.

In an example development of the invention, it is provided to store in relation to at least one (in particular atomic) element of the user interface—in addition to the specification—a distribution instruction which defines the arrangement of the element or an instance of the same on the user interface and/or the assignment of the element or instance to a specific structure of the user interface. The “structure” of the user interface is in particular a frame, a window or a layer (tab) of the user interface. In an example embodiment of the invention in which the user interface is distributed over a plurality of screens, a specific screen, or more precisely a subarea of the user interface assigned to a specific screen, is preferably assigned as the structure. The distribution instruction can—like the specification—be arranged optionally within the scope of the application or in a configuration file assigned thereto. In the latter case the specification and the distribution instruction can optionally be stored in the same configuration file or in different configuration files.

In an example embodiment of the invention, each UI element is created and/or destroyed by the part factory in response to a corresponding call or, as the case may be, corresponding instruction by the application. The part factory, in a preferred embodiment in reality a runtime component of the same which comprises the actual logic for creating (instantiating) and destroying the UI element, has for this purpose a defined interface via which the application accesses the part factory or, as the case may be, its runtime component.

In an example embodiment the part factory additionally includes a parsing module which reads in the stored specification and—if present—the distribution instruction.

In the narrower sense the above-described system, includes software which has the above-described functionality. Thus, the runtime environment and the part factory in particular are software components. In a wider sense, however, a computer system, in other words computer hardware on which the components are necessarily implemented in the operational state, is also considered as part of the system. According to this wider definition the system comprises hardware and software components.

### BRIEF DESCRIPTION OF THE DRAWINGS

An example embodiment of the invention is explained in more detail below with reference to the drawing:

The sole FIGURE shows in a schematically greatly simplified block diagram a system for controlling the user interface of a medical software application.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,”,“an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

In the wider sense the system comprises a computer system 1 to which are connected two screens 2 and 3 and input devices (not shown in greater detail) such as e.g. a keyboard, a computer mouse, etc. The computer system 1 may be a single computer. Preferably, however, the computer system includes (in a manner not shown in greater detail) a plurality of computers networked in a client-server structure for data communication purposes.

In the narrower sense the system is essentially formed by a framework 4 implemented in the computer system 1 and comprising, inter alia, a runtime environment 5 as well as an element creation module (referred to in the remainder of this description as a part factory 6) which can be executed in the runtime environment 5. The framework 4 is in particular a domain-specific framework for the field of medical imaging. For their part, however, the domain-specific components of the framework 4 can be built on the basis of a so-called generic framework, i.e. one that is independent of a specific field of application, for example the .NET framework of the company Microsoft. In the latter case the runtime environment 5 is in particular the Common Language Runtime of the .NET framework. The framework 4, for its part, is built on the basis of an operating system 7 of the computer system 1.

Also depicted by way of example in the FIGURE is a (software) application 8 which runs in keeping with its intended purpose in the framework 4 and the assigned runtime environment 5. Among other components the application 8 includes a user interface 9. In the example shown the user interface 9 comprises two subareas 10 and 11, the subarea 10 being displayed on the screen 2, and the subarea 11 on the screen 3.

Two configuration files 12 and 13 which are stored in a memory (not shown in further detail) of the computer system 1 are assigned to the application 8. The configuration file 12 comprises a number of specifications S for atomic elements 14 of the user interface 9 which specify the type and attributes of the elements 14 in the manner described in the introduction. The configuration file 12, for example, includes, inter alia, a specification S of an element 14 of the type “slider”. Within the scope of the specification S the following attributes, for example, are specified in relation to the element 14:
pointer to a graphics file which defines the visual appearance of the slider including its color scheme,
size, e.g. 120×45 pixels or scaling factor,
marginal values, e.g. −5 and +5, and
rastering, e.g. 0.1.

For each element 14 specified in the configuration file 12 there is stored in the configuration file 13 an associated distribution instruction V which specifies the arrangement of the respective element 14 on the user interface 9, and in particular the assignment of the element 14 to one of the subareas 10 and 11. With regard to the above-described slider, there is stored in the configuration file 13 for example the distribution instruction directing the slider to be arranged at a specific position of the subarea 10.

The configuration files 12 and 13 are usually co-created by the application developer during the process of developing the application 8 and are stored in the memory of the computer system 1 in the course of the installation of the application 8. Accordingly, the configuration files 12 and 13 are already available at the start time of the application 8.

The part factory 6 serves to create and destroy the elements 14 on the user interface 9 at the runtime of the application 8. For this purpose it comprises a runtime component 15 and a parsing module 16.

At the start of the application 8 the user interface 9 is first built up by the application 8 in an initial state. In said initial state the user interface 9 comprises only a subset of the totality of UI elements available to it. In particular the elements 14 controlled by the part factory 6 are not created and displayed immediately.

Corresponding to the user interface 9, an object model 17 containing the code assigned to the UI elements is generated by the framework 4. In real terms the object model 17 includes instructions in relation to each UI element contained in the user interface 9, the instructions defining the sequence of an actuation of the respective UI element, i.e. generating a specific output signal for example when a button contained as a UI element in the user interface 9 is actuated. In addition the object model 17 contains instructions which define the interaction between different elements of the user interface 9, for example the instruction to illuminate a specific indicator lamp contained as a UI element in the user interface 9 when a specific button included as a further UI element in the user interface 9 is actuated.

In order to build the object model 17 the framework 4 resorts to the information relating to the respective UI elements that is contained in the configuration files 12 and 13.

Like the user interface 9, the object model 17 is also generated at the start of the application 8, in the first instance in an initial state in which it contains only instructions relating to the initially present UI elements of the user interface 9.

If one of the elements 14 not already created at the program start is required at the runtime of the application 8, the application 8 accesses the runtime component 15 via an interface 18 of the runtime component 15 provided for that purpose, whereupon the runtime component 15 creates the element 14 in the user interface 9 of the application 8. Similarly, the runtime component 15 destroys the element 14 at the runtime of the application 8 again, i.e. deletes it from the user interface 9, as soon as it receives a corresponding instruction from the application 8 via the interface 18.

Each time an element 14 is created or destroyed at the runtime of the application 8, the object model 17 is updated in a corresponding manner by the part factory 6. With the creation of each new element 14 in the user interface 9, the part factory 6 in particular supplements the object model 17 with the instructions assigned to the element 14. In order to generate said instructions the part factory 6 in the process reads in the associated information from the configuration files 12 and 13 by way of the parsing module 16. Analogously, each time an element 14 is destroyed the part factory also deletes the associated instructions in each case from the object model 17.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

### LIST OF REFERENCE SIGNS

1 Computer system
2 Screen
3 Screen
4 Framework
5 Runtime environment
6 Part factory
7 Operating system
8 (Software) application
9 User interface
10 Subarea
11 Subarea
12 Configuration file
13 Configuration file
14 Element
15 Runtime component
16 Parsing module
17 Object model
18 Interface
S Specification
V Distribution instruction

What is claimed is:

1. A method for controlling a user interface of a software application executed in a runtime environment, the method comprising:
storing, in relation to at least one element of the user interface and within the scope of the application or a configuration file assigned thereto, a specification defining a type and attributes of said at least one element; and
creating, after starting the application, the at least one element by an element control module separate from the application in accordance with the associated specification.

2. The method as claimed in claim 1, wherein the element control module is executed in the runtime environment.

3. The method as claimed in claim 1, wherein the element control module is implemented in an application-independent manner as part of the framework.

4. The method as claimed in claim 1, further comprising:
storing, in relation to at least one element of the user interface and within the scope of the application or a configuration file assigned thereto, a distribution instruction which determines at least one of the arrangement of the element on the user interface and the assignment of the element to a specific structure of the user interface.

5. The method as claimed in claim 1, wherein the at least one element is at least one of created and destroyed by the element control module in response to a call by the application.

6. A system for controlling a user interface of a software application, said system comprising:
a runtime environment in which the software application is executable; and
an element creation module for creating at least one element of the user interface, wherein the element creation module is implemented separately from the software application and wherein the element creation module is configured to create the at least one element after the start of the software application in accordance with a specification stored within the scope of the application or a configuration file assigned thereto, and to define a type and attributes of the at least one element.

7. The system as claimed in claim 6, wherein the element creation module is executable in the runtime environment.

8. The system as claimed in claim 6, wherein the element creation module is implemented as part of an application-independent framework.

9. The system as claimed in claim 6, wherein the element creation module includes a parsing module for reading in the stored specification, and also a runtime component for instantiating the at least one element configured in accordance with the specification.

10. The system as claimed in claim 6, wherein the element creation module is configured at least one of
to arrange the at least one element on the user interface and
to assign the at least one element to a specific structure of the user interface after the start of the software application in accordance with a distribution instruction stored within the scope of the application or a configuration file assigned thereto.

11. The system as claimed in claim 10, wherein the user interface is configured for the purpose of the distributed display of the user interface on a plurality of screens, and wherein the element creation module is configured to assign the at least one element to a specific screen in accordance with the distribution instruction.

12. The method as claimed in claim 2, wherein the element control module is implemented in an application-independent manner as part of the framework.

13. The method as claimed in claim 2, wherein the at least one element is at least one of created and destroyed by the element control module in response to a call by the application.

14. The method as claimed in claim 3, wherein the at least one element is at least one of created and destroyed by the element control module in response to a call by the application.

15. The system as claimed in claim 7, wherein the element creation module is implemented as part of an application-independent framework.

16. The system as claimed in claim 7, wherein the element creation module includes a parsing module for reading in the stored specification, and also a runtime component for instantiating the at least one element configured in accordance with the specification.

17. The system as claimed in claim 8, wherein the element creation module includes a parsing module for reading in the stored specification, and also a runtime component for instantiating the at least one element configured in accordance with the specification.
